(19) United States
(12) Patent Application Publication
(10) Pub. No.: US 2025/0196278 A1
(43) Pub. Date: Jun. 19, 2025

(54) Method for producing building elements

(71) Applicant: WEINMANN Holzbausystemtechnik GmbH, St. Johann (DE)

(72) Inventors: Mathias Wagner, Ditzingen (DE); Michael Goller, Münsingen (DE); Jörg Groß, Hohenstein Wuertt (DE)

(21) Appl. No.: 18/972,568

(22) Filed: Dec. 6, 2024

(30) Foreign Application Priority Data
Dec. 14, 2023 (DE) 102023135130.3

(51) Int. Cl. B23P 21/00; B23P 15/00; F16B 5/12

(52) U.S. Cl. CPC B23P 21/00; B23P 15/00; F16B 5/12

(57) ABSTRACT

The invention relates to a method for producing multi-part building elements comprising a plurality of supporting elements, comprising the following operating steps: Positioning supporting elements on a work table and fastening them to one another in such a manner that a support structure is created; providing and depositing a slab-shaped component on the supporting building element, wherein the slab-shaped component is deposited in such a manner that the support structure is at least approximately covered on the side to be deposited; and fastening the slab-shaped component to the supporting elements. This makes it possible for the first time to provide an improved method with a higher flexibility and/or with a greater integration depth of components, for producing multi-part building elements.

The invention relates to a method for producing multi-part building elements, according to claim 1, and to a prefabrication line and to a manufacturing plant for producing building elements.

The production of prefabricated building elements could in future take place on an industrial scale. In this type of production, building elements of a building are prefabricated in a manufacturing plant. The prefabricated building elements are then delivered to a remote building site and assembled there. Such prefabricated building elements can be used for a multiplicity of purposes, inter alia as temporary or permanent buildings, such as residential buildings, multi-storey buildings, commercial offices, educational or service facilities.

Methods for producing building elements currently have a high degree of manual processing steps, whereby the individual method steps of a manufacturing plant are generally inflexibly adapted to one another. Moreover, the integration depth of individual components into the prefabricated building elements is very minor, this requiring a high manual effort at a remote building site when erecting the building.

It is therefore the object of the present invention to provide an improved method, or at least an alternative method, for producing multi-part building elements. In particular, a method with a higher flexibility and/or with a greater integration depth of components is to be proposed.

This object is achieved by the subject matter of the independent patent claims. Preferred embodiments are the subject matter of the dependent patent claims.

The present invention relates firstly to a method for producing multi-part building elements, having a plurality of supporting elements, in particular support beams, comprising the following operating steps: Positioning the supporting elements on a work table. Producing a support structure by fastening the supporting elements to one another and/or fixing the supporting elements to one another. Providing and depositing a slab-shaped component on the support structure, wherein the slab-shaped component is deposited in such a manner that the latter at least approximately covers the support structure on one side. Fastening the slab-shaped component to the support structure. By an adapted combination of supporting elements and slab-shaped components, it is possible to provide a method for producing a building element, which has a high flexibility with regard to the design, in particular with regard to the size and/or the construction of the building elements.

For the purposes of the present invention, a building element is understood to mean both a static load bearing as well as a non-load bearing part of a building. In particular, this should be understood to include wall, ceiling, floor and/or roof elements of a building. Building elements within the context of the invention comprise a multiplicity of components, in particular supporting elements, slab-shaped components, connecting elements and/or fastening elements.

A supporting element is understood to mean a component that when assembled is part of a support structure of the building element. This includes, inter alia, support beams, support posts, adhesively bonded support beam structures or trusses. Supporting elements can comprise a multiplicity of materials, including materials made from renewable raw materials, in particular wood and wood-based materials, wood composites, plastics, metals, or any other material preferred for the characteristic as a supporting element. In a preferred design embodiment, a supporting element comprises a sandwich construction having a layer of a material of a renewable raw material and a layer of a plastic, in particular a recycled plastic and/or a mixture of a plastic and a wood-fibre material. In a further preferred design embodiment, certain supporting elements are constructed from wood, wood-based material and/or a wood composite material, because these have a stability required for building elements and can be easily processed. Wood and/or wood-based materials are renewable raw materials and therefore are readily available in the quantities required for the building elements; they can be stored and thus kept ready without technical difficulties.

In the context of the present invention, slab-shaped components are understood to be components which have a flat, at least approximately planar, structure and have a minor thickness in relation to the extent of the surface. The slab-shaped components achieve a multiplicity of tasks. Inter alia, the slab-shaped components are provided for covering and/or closing the support structure. Further tasks of the slab-shaped components can be support functions for additional components of the building elements. In particular, different slab-shaped components can be used for this purpose. The different slab-shaped components achieve various tasks that are set for modern building elements. In particular, the slab-shaped components achieve fire protection, sound insulation, and heat and/or cold protection tasks. At the same time, they can contribute towards reinforcing a support structure connected to them after installation. Slab-shaped components can comprise a multiplicity of materials, including wood, wood-based materials, wood-fibre systems, especially soft wood fibres, wood composites, plastics, gypsum, fibrous gypsum material, mixtures of said materials and/or any other material required for the respectively desired property. In a preferred design embodiment, the slab-shaped components are substantially produced from a wood-based material. In a particularly preferred design embodiment, the slab-shaped components can be substantially produced from a gypsum material and/or a fibrous gypsum material in order to comply with special fire protection requirements for the building elements. In an alternative design embodiment of the slab-shaped components with one or a plurality of material layers made of soft wood fibres, increased sound insulation for the building elements is implemented. In another particularly preferred design embodiment, the slab-shaped component has a plurality of layers of different materials, in particular layers of a plastic material, of a material of naturally renewable raw materials, in particular wood, and/or of a gypsum material. A combination of different materials in a single slab-shaped component means that the requirements for fire protection, sound insulation, and heat and/or cold protection can be met with only this one slab-shaped component.

In particularly preferred design embodiments, individual slab-shaped components can be combined with one another to achieve the respective characteristics for the building elements.

In a preferred design embodiment of the method according to claim 1, the slab-shaped component is processed in one or a plurality of prefabrication lines in such a manner that the slab-shaped component corresponds to a dimension X of the support structure. In a preferred design embodiment, the dimension X corresponds at least approximately to the height of the support structure. In an alternative design embodiment, the dimension X corresponds to an undersize of the height of the support structure. In the present context of the invention, a height of a support structure is understood to mean the dimension which the support structure has in the vertically constructed state from the geodetically lower end of the component to the geodetically upper end of the component.

An undersize is understood to be a dimension which is smaller by a difference than the height of the support structure. By processing the slab-shaped components in a prefabrication line, it is possible to deposit the slab-shaped components on the support structure and to fasten them in such a manner that they are at least approximately flush with the supporting elements. This reduces the post-processing operations required to date, or eliminates them in particularly preferred cases.

In a prefabrication line in the context of the invention, an upstream processing step of a component of a building element, in particular of the supporting elements and/or the slab-shaped components, can be carried out. This makes it possible to design the process for producing the building elements on a main production line to be more flexible, as necessary processing steps are carried out at one or a plurality of prefabrication lines.

A prefabrication line of the manufacturing plant comprises, for example, a first prefabrication installation, a second prefabrication installation, a third prefabrication installation and/or a fourth prefabrication installation. The numbering is used here to distinguish, but not to establish, a specific number of prefabrication installations.

Preferably, the manufacturing plant has a second prefabrication line. The latter can comprise a first storage for storing slab-shaped components, a slab cutting device for processing the slab-shaped components and, in particular, a second storage. The second storage is designed in such a manner that the processed slab-shaped components are deposited in the second storage in reverse order for retrieval for a downstream processing step. Preferably, a conveyor unit, in particular an autonomous conveyor unit, is assigned to the second storage, by which the processed slab-shaped components are fed to the main production line.

A slab cutting device for processing the slab-shaped components shall be understood to mean any processing device which can be used for length adjustment and/or for generating a recess or clearance. In particular, all subtractive machining devices, in particular sawing, cutting, planing, grinding and milling devices, are to be understood to be the slab cutting device according to the invention.

A storage in the context of the invention is understood to mean any storage device in which slab-shaped components are to be stored. In particular, this refers to storage devices in which slabs are to be stored upright and/or in a type of multi-level rack system. In an alternative design embodiment, the storage can be designed in such a manner that the slab-shaped components to be stored can be stored in the storage device so as to be sorted by size. In a further alternative design embodiment, the storage device can be designed to be movable, in particular autonomously movable, so as to transport the stored slabs from the second prefabrication line to the main production line. A movable storage device of this type can comprise one or a plurality of driverless transport vehicles.

In the context of the invention, a conveyor unit is understood to mean any conveyor device which can be used for conveying the components processed on the prefabrication installation or line. In particular, a conveyor unit is to be understood to be a robot, which automatically or autonomously transports the components to be conveyed from a prefabrication installation or line to the main production line. Particularly preferably, a conveyor unit can alternatively or additionally comprise one or a plurality of driverless transport vehicles. In an alternative design embodiment, a linear conveyor device, in particular a chain conveyor, a roller conveyor and/or a conveyor belt can be understood to be a conveyor unit.

In a further preferred design embodiment, a slab-shaped component is processed in a prefabrication line in such a manner that the slab-shaped component at least partially has a clearance. In a preferred design embodiment, the clearance can be configured for a passage, a door, a window and/or another component. Particularly preferably, further processing steps, in particular the chamfering of the edge regions and/or the incorporation of bores, can be provided for the slab-shaped components. In the present invention, chamfering is understood to mean the tapering and/or bevelling of the edges of the slab-shaped components and/or of the generated cut edges of the slab-shaped components.

In a further particularly preferred method step, the slab-shaped component comprising a clearance or at least a part of a clearance on the support structure is deposited and positioned so as to be approximately congruent with a clearance in the support structure. If the at least partial clearance is incorporated into a slab-shaped component in one of the prefabrication lines, this results in a particularly flexible main production line to and on which already pre-assembled components can then be delivered and installed. This allows for a high variance of building elements to be processed on the main production line.

In a preferred design embodiment, the slab-shaped component with the clearance is deposited and positioned on the support structure in such a manner that an edge of the slab-shaped component is approximately parallel to an edge of a clearance in the building element. This makes it possible to easily position a clearance of the slab-shaped components in the building element in such a manner that the clearance of the slab-shaped component and the clearance of the building element are co-aligned.

In a further preferred design embodiment of the method, a slab-shaped component is deposited, positioned and/or fastened at and/or on the support structure by means of a robot, wherein the robot selects the slab-shaped component from a supply of processed slab-shaped components and from a supply of additional slab-shaped components in such a manner that the support structure is at least partially covered, wherein the slabs processed by a prefabrication line and/or the additional slabs are conveyed by way of a conveyor unit, in particular an autonomous conveyor unit, to a robot. This makes it possible to provide at least a semi-automated, in particular fully automated, method step of a main production line for the production of building elements.

In a further preferred design embodiment of the method, a multiplicity of slab-shaped components are deposited on the support structure in such a manner that the slab-shaped components form a first layer on the support structure. Two mutually adjacent slab-shaped components have a contact region. This contact region is positioned at least approximately in the centre of a supporting element. In relation to the supporting elements, the slab-shaped components have a linear coefficient of expansion a which is 1.5 to 10 times higher. In a preferred design embodiment, the linear coefficient of expansion a can be 3 to 6 times higher. The linear coefficient of expansion a describes the behaviour of a substance in terms of the change in its dimensions in the event of a change in temperature dT. The linear coefficient of expansion a of a component with length L is the proportionality constant between the change in temperature dT and the relative change in length dL/L, where dL corresponds to the change in length of the component. It is accordingly used to describe the relative change in length when a temperature change occurs. It is a substance-specific variable which has the unit K⁻¹ and is defined by the following equation

$$α L = \frac{d L}{d T} .$$

It is thus possible to produce building elements in such a manner that the building elements have a similar linear expansion at different temperatures at the manufacturing plant and at the construction site. This creates only minor stresses between the individual components. Due to the lower stresses between the individual components, fewer relative movements are generated within the individual building elements. This means that a lower tolerance coordination between the individual building elements is necessary.

In a further preferred method step of the method according to the invention, an additional slab-shaped component is deposited and/or positioned on the slab-shaped component which forms a first layer on the support structure.

By placing an additional slab-shaped component, it is possible to create different structures of building elements. Thus, it is possible to provide a building element with at least two layers of slab-shaped components, whereby a combination of the desired fire protection, sound insulation, and heat and/or cold protection characteristics is made possible in a simple manner, without affecting the further characteristics of the building element.

In a particularly preferred design embodiment, the method step can be repeated several times to create a structure of the building element with a plurality of layers. Preferably, the slab-shaped components of one layer are deposited next to one another in such a manner that the individual slab-shaped components bear on one another, wherein a butt joint is created between the individual slab-shaped components. The slab-shaped components of an additional layer are preferably deposited so as to be offset on the slab-shaped components of the one layer in such a manner that the butt joint of the slab-shaped components of the one layer is covered by the slab-shaped components of the additional layer. Particularly preferably, the slab-shaped components of the additional layer are deposited on the slab-shaped components of the one layer in such a manner that the butt joint of the slab-shaped components of the one layer is disposed approximately centrally to the slab-shaped components of the additional layer. Preferably, the slab-shaped components of the one and of the additional layer are produced of a gypsum and/or fibrous gypsum material. Thus, it is possible to combine a particularly high stiffness of the building element with a combination of the desired fire protection, sound insulation, and heat and/or cold protection characteristics in such a manner that the building element is suitable for the multi-storey construction of an apartment building.

In a further preferred design embodiment of the method, a slab-shaped component is processed with an assembly unit in the third prefabrication installation in such a manner that an additional component is added to the slab-shaped component. This additional component can be part of a shading system. In another preferred design embodiment, the part of the shading system is a housing of a shading system, such as a roller shutter box or a receptacle housing for a blind. In a particularly preferred design embodiment, the part of the shading system is a supply line, for example a power and/or data cable, to supply the shading system with power and/or to actuate said shading system by way of a controller.

In a particularly preferred design embodiment, the slab-shaped component is processed in the third prefabrication installation in such a manner that the slab-shaped component has a multiplicity of additional components, in particular a combination of parts of a shading system. In a further particularly preferred design embodiment, the additional components of the individual building elements, which in a downstream step are constructed on the construction site so as to be disposed on one another, are mutually aligned in such a manner that the respective additional components of the one building element can be coupled to an additional component of another building element, in particular coupled by way of an additional adapter component. This makes it possible to provide a shading system above a planned corner glazing of a building. It is hereby likewise possible that a switch for actuating the shading system is provided on one building element while the shading system is disposed on another building element.

Preferably, the third prefabrication installation has an assembly unit for fastening a component to a slab-shaped component, wherein the component is a part or a combination of parts of a shading system. By fastening an additional component in the third prefabrication installation, it is possible to provide an increased integration depth of the building elements, associated with a high flexibility of the main production line.

Preferably, the manufacturing plant has a multiplicity of third prefabrication installations for fastening additional components to a slab-shaped component. This creates the possibility of splitting additional components of the shading system in such a manner that an efficient workflow is provided. In a particularly preferred design embodiment, the individual prefabrication installations can be mutually disposed in such a manner that the processed slab-shaped components are either conveyed directly to the main production line or to a further prefabrication installation in order to fasten a possible further additional component.

In a further preferred design embodiment of the method, the slab-shaped component is disposed on the support structure in such a manner that the protruding additional component of the slab-shaped component projects into a space between two supporting elements of the support structure. This makes it possible to place one or a plurality of additional components in a space-saving manner in the building element. Moreover, an additional component is positioned in a protected manner for further assembly and/or transport, as it is located between the supporting elements in the inside of the building element and does not protrude from the building element, thus preventing or at least reducing the risk of breaking off, shearing or similar damage during transport or assembly of the building element at the construction site.

In a particularly preferred design embodiment of the method, the building element has a first layer of slab-shaped components, which has a clearance, in particular a clearance which is formed by a subtractive machining method on at least one slab-shaped component of the first layer. The clearance is designed in such a manner that the additional component of the slab-shaped component in the assembled state protrudes into the clearance. The proposed structure of the building element makes it possible to provide the space between the supporting elements of the heat and/or cold insulating layer and to integrate the additional component into a multi-layer structure of the slab-shaped components.

In an alternative construction of the building element, the layer having the clearance for the additional component has soft wood fibre material. Soft wood fibre material has a good sound insulation index, which means that an additional sound insulation casing of the additional component can be avoided in the case of sanitary and/or ventilation system components.

In a further preferred design embodiment of the method, a plurality of supporting elements are processed to form a support structure of a building element on a main production line with a processing device, while a component of a building element is processed simultaneously on a prefabrication line which has a prefabrication installation in the form of a further processing device for the processing of a component of a building element. In particular, a component of the same building element is processed on the prefabrication line for which a support structure is being produced on the main production line. In this case, the component and the support structure are connected to one another in subsequent method steps. In a modified variant, a component of another additional building element is processed on the prefabrication line, which is connected to another additional support structure in a later method step.

In a particularly preferred embodiment, a plurality of prefabrication installations form a prefabrication line which is assigned to a main production line, wherein different components are processed simultaneously in the prefabrication line and in the main production line. After processing on the prefabrication line, components are conveyed from there to a storage unit and/or directly to the main production line. This makes it possible to process a plurality of components flexibly on the main production line and on the prefabrication line at the same time, which can increase the production volume per unit of time, as required preliminary work can simultaneously be carried out flexibly in the prefabrication installations.

In a further preferred design embodiment of the method, a component is processed on a prefabrication line and subsequently conveyed to a processing device of the main production line in order to generate a building element.

In particular, a multiplicity of components are processed simultaneously and/or with a temporal offset on a multiplicity of prefabrication installations. The multiplicity of processed components are conveyed to the corresponding processing devices of the main production line for subsequent processing, or to a storage area. Thus, a production of the building elements on the main production line can be designed to be very flexible because the components necessary for the production are available and thus the production volume per unit of time can be increased.

In a particularly preferred design embodiment, the component is conveyed autonomously from a prefabrication line to the main production line, in particular with the aid of a robot, this requiring fewer personnel for the production of the building elements.

In a further preferred design embodiment of the method, the method comprises the following further steps: Turning the building element in such a manner that the support structure bears on the slab-shaped component on a work table in such a manner that a space between the supporting elements is accessible. Inserting a structural component onto the slab-shaped component in the space between the supporting elements of the building element. Incorporating a filler material into the space between the supporting elements, wherein the filler material is distributed in the space and at least approximately held in position by means of the structural component.

In the context of the invention, a structural component is understood to mean a three-dimensional structure, in particular a web or a strut. In an alternative design embodiment, a structure with a lattice, a rectangular, a diamond, a circular and/or a honeycomb structure, comprising webs and/or struts, is understood to be a structural component. The rectangles, rhombs, circles and/or honeycombs form chambers (where necessary with the webs) into which the filler material can be incorporated. The structure subdivides a filler material to be subsequently incorporated into separate sub-quantities and holds the filler material at least approximately in position. In the context of the present aspect of the invention, the term “held in position and/or held” means that only a small amount of freedom of movement is allowed for the filler material. This ensures that a uniform distribution of the filler material is maintained. The chambers reduce the freedom of movement of the bulk material to the chambers, which results in less settling and/or abrasion of the bulk material. This makes it possible to easily provide uniform sound insulation, and heat and/or cold protection in a building element. The structural component can be fastened to both the supporting elements and to a slab-shaped component facing the structural component. By fastening the structural component to the supporting elements and/or the slab-shaped components, the building element is additionally reinforced. A friction-fitting and form-fitting fastening connection, in particular a clamping connection, a threaded connection, a rivet connection and/or a snap-fitting connection of the component can be provided as a fastening. In a preferred design embodiment, the structural component is incorporated into the cavity of the building element in such a manner that the structural component can be moved within the building element towards the supporting elements. The structural component can also be used without using a filler material. By incorporating the filler material into the cavity, an inserted structural component is at least approximately held in position owing to the distribution of the filler material about the structural component and between the supporting elements. In a preferred embodiment, the structural component comprises a fibrous material, particularly preferably a plastic, in particular a recycled plastic, a kraft paper and/or a composite material of plastic and fibres. A structural component made of such a material can be manufactured in a particularly cost-effective manner. In an alternative preferred design embodiment, the structural component comprises a metallic, in particular a low-corrosion metallic, material. A structural component made of a metallic material can transmit particularly high forces and reinforces a building element particularly well.

For the purposes of the invention, a filler material is understood to mean any free-flowing, injectable, foam-like and/or insertable material which is suitable for filling an installation space. In particular, inert bulk materials, in particular plastics, and/or naturally produced free-flowing materials, such as split and/or perlite, are to be understood to be the free-flowing material.

In a further preferred design embodiment of the method, the filler material comprises a bulk material, an injectable material and/or an insertable material. The bulk material can in particular be an inert bulk material, having a grain size of 1 mm to 10 mm, preferably having a grain size of 2 mm to 5 mm. The injectable material can in particular comprise a fibre-based and/or spherical material. Soft wood fibres, cellulose or plastic balls are particularly preferably used as an injectable material. The insertable material can include, in particular, a fibrous web material, preferably a wood-fibrous web material.

In further studies, the injectable material has proved to be particularly successful in the combination of sound, heat and/or cold insulation.

An insertable material is to be understood to mean in particular insulation mats, preferably comprising a fibrous material, of the already mentioned substances. The enumerations of the individual materials are not intended to be understood to be exhaustive in the context of the invention. Combinations of the mentioned materials can also be used for the specific application.

In a further preferred embodiment of the method, the structural component has a three-dimensional structure with a plurality of struts and/or webs, which in top view has the shape of a multiplicity of circles, rectangles and/or honeycombs. Studies have shown that with the help of the structures mentioned, in particular the honeycomb structure, a homogeneous distribution of the bulk material is facilitated and the bulk material is particularly advantageously held in position.

Provided between the supporting elements is preferably a structural component mentioned above, wherein the height of the structural component corresponds to approx. 50 to 75% of the height of the supporting elements. A bulk material of the above type is used to fill the structural component. In a further method step, an insertable filler material is deposited on the structural component, wherein the height of the insertable filler material is chosen in such a manner that the height of the bulk material and the height of the insertable filler material in total correspond to the height of the supporting elements. In a particularly preferred embodiment, the sum of the height of the bulk material and of the insertable filler material can be implemented with a (small) oversize, in particular with an oversize of 1% to 10%, in relation to the height of the supporting elements. In a further method step, bulk material and/or filler material are compressed to the height of the supporting elements with the aid of a slab-shaped component, whereby the bulk material and/or the filler material are kept in position in a particularly reliable manner. This also makes it possible to combine the characteristics of the various filler materials in such a manner that different characteristics, in particular fire protection, sound insulation, and heat and/or cold protection, can be easily integrated into one building element.

In a further preferred design embodiment of the method, the structural component has a fibrous material having a plurality of approximately hexagonal honeycomb structures. The structural component is covered on one side with a slab-shaped fibrous element. This keeps the bulk material approximately in position. The structural component preferably has a height of 20 mm to 300 mm, in particular 60 mm to 150 mm. The bulk material comprises a free-flowing material with a bulk density of 1000 kg/m³ to 2000 kg/m³, preferably 1400 kg/m³ to 1600 kg/m³. Due to this special design embodiment it is possible to provide a particularly well sound-insulated building element, since the bulk material has a high bulk density, whereby sound is well reflected and/or absorbed. In the case of a bulk material with a bulk density of 1000 kg/m³ to 2000 kg/m³, a particularly stiff structural component is advantageous in order to prevent deformation of the structural component and to keep the bulk material in position.

In a further preferred design embodiment of the method, the support structure is populated with slab-shaped components, wherein the slab-shaped components are deposited on the support structure in such a manner that a structural component and/or a filler material are enclosed from a plurality of sides by the support structure and the slab-shaped components. The structural component preferably has honeycomb-shaped chambers. A bulk material is disposed in the chambers. By depositing the slab-shaped components, the bulk material is enclosed in the chambers. By enclosing the bulk material in the chambers, the bulk material can only move in the region of one chamber. As a result, if the bulk material should move, the centre of mass of the building element shifts only slightly due to movements of the building element.

In an alternative method step, the building element is populated with a plurality of layers of slab-shaped components, whereby the (optionally honeycomb-shaped) structural component is closed. The different layers of slab-shaped components reinforce the entire building element. A reinforcement is particularly relevant for filler materials with a high bulk density, in particular a bulk density of approximately 1400 kg/m³, in order to avoid flexing of the building elements. In addition, an additional layer of a sound-absorbing material can be used, which improves sound insulation.

The invention furthermore relates to a prefabrication line for processing components of the building elements. The prefabrication line has an assembly unit or a slab cutting device for processing slab-shaped components. Furthermore, the prefabrication line preferably has a module storage or a second storage. Depositing the processed slab-shaped components in the module storage or in the second storage is carried out in the reverse order for retrieval for a downstream processing step. The prefabrication line has a conveyor unit to feed the processed slab-shaped components to the main production line. Preferably, the conveyor unit is an autonomous conveyor unit.

The prefabrication line allows components to be preconfigured for the main production line. This allows a variable production of different building elements on a main production line.

In a preferred design embodiment of the prefabrication line, the assembly unit or the slab cutting device comprises a subtractive machining device for adjusting the dimensions or for creating clearances in one of the slab-shaped components. Preferably, the subtractive machine tool is a milling, sawing and/or cutting device.

As a result, the slab-shaped components of the building elements for the main production line can already be adapted in the prefabrication line.

In another preferred design embodiment of the prefabrication line, the assembly unit comprises a processing device for fastening a component to a slab-shaped component. The component comprises a part of a shading system. The part of the shading system is preferably a housing of a shading system and/or a power and/or data cable for supplying and/or actuating the shading system.

This makes it possible to assemble individual components of the building elements to be produced on components of the building elements in a prefabrication line. This increases the efficiency of the main production line.

The invention furthermore relates to a manufacturing plant for the production of multi-part building elements. The manufacturing plant comprises a main production line having a processing device and a prefabrication line, wherein the prefabrication line is disposed in the region of the corresponding processing device of the main production line in such a manner that the processed component of the prefabrication line is conveyed to the corresponding processing device of the main production line at the time of further processing. This provides a flexible main production line that enables complex building elements with a high degree of vertical integration. The manufacturing plant is particularly suitable and provided for carrying out the above-described method.

In a preferred design embodiment, the manufacturing plant has a main production line having a first plurality of processing devices which are disposed in a line behind one another. The manufacturing plant moreover has a prefabrication line having a second plurality of processing devices. The prefabrication line is located on a side adjacent to the main production line. Preferably, the prefabrication line is disposed between the main production line and a supporting structure of a factory shed.

The supporting structure allows additional processing devices, fixtures and/or components for processing on the prefabrication line and/or the main production line to be fastened to the supporting structure. This makes it possible to keep the installation space required for the processing devices small. This makes it possible that the processing devices of the prefabrication lines can be supplied by way of a connecting path and the distances of the processing devices of the prefabrication line to the processing devices of the main production line are kept short. In addition, the area required for the processing devices of the prefabrication line can be kept to a minimum. In addition, the conveying paths can be kept short.

In a further preferred design embodiment, the manufacturing plant has a second prefabrication line with the following subunits: A first storage, a slab cutting device, in particular a subtractive machining device for slab-shaped components, and a second storage for processed slab-shaped components. The processing device can in particular comprise a milling, a sawing, a grinding and/or a cutting device to carry out the assembly of the slab-shaped components to be processed. The first storage, the slab cutting device and the second storage are disposed in a line behind one another. The second prefabrication line is disposed in particular almost orthogonally in relation to the main production line, and in particular on the opposite side of the main production line in terms of a first prefabrication line. A conveyor unit is provided between the second storage of the second prefabrication line and one or a plurality of the processing devices of the main production line. In a preferred design embodiment, the conveyor unit can be an autonomous conveyor unit. This enables a particularly flexible connection of a prefabrication line to the main production line. Preferably, both the first storage and the second storage of the second prefabrication line can be operated from a plurality of sides, whereby a plurality of conveyor units can convey, in particular simultaneously, the processed components from the second storage to a plurality of processing devices of the main production line.

In particular, a main production line according to the invention has one or a plurality of the workstations described below:

A support structure station which is configured to form a support structure. The support structure station is configured in such a manner that it can be used to produce a support structure of a building element by positioning and fixing the supporting elements between an upper and a lower supporting element, the upper supporting element defining an upper edge and the lower supporting element defining a lower edge of a building element, wherein vertical and/or internal supporting elements are processed, preferably milled, drilled and/or sawn to the defined dimensions, in a first prefabrication installation. The configured supporting elements for the support structure station are subsequently provided. In a preferred embodiment, the supporting elements are fastened to one another in the support structure station in such a manner that the support structure has clearances in order to provide windows and/or doors in the building element.

A covering station which is configured to position one or a multiplicity of slab-shaped components that are provided to the station by way of a transport device and/or a storage area on a previously produced support structure. In a preferred design embodiment, the covering station is configured in such a manner that the slab-shaped components are positioned at least approximately flush with a supporting element, in particular the upper and/or the lower supporting element, of the support structure. In an alternative design embodiment, the slab-shaped components are placed in a predetermined pattern on the support structure. The predetermined pattern for the placement of the slab-shaped components is created with the aid of a computer simulation, wherein at least the dimensions of the support structure, as well as the position and size of the clearances are specified for creating said pattern. Preferably, the predetermined pattern for the placement of the slab-shaped components is created with the aid of a computer simulation based on a static calculation of the building construction to be erected later. The covering station is furthermore configured in such a manner that the slab-shaped components are at least temporarily fastened to the support structure with a plurality of fastening elements, wherein the fastening elements are positioned in such a manner that they engage in the support structure. In a preferred embodiment, the covering station is configured in such a manner that an additional layer of slab-shaped components is positioned and deposited on the already fastened layer of slab-shaped components. The slab-shaped components are preconfigured in such a manner that they have at least approximately the same dimensions as the slab-shaped components of the first layer. In a particularly preferred embodiment, the slab-shaped components of the second layer have different dimensions than the slab-shaped components of the first layer, or they are positioned and deposited in a different position to the first layer. This makes it possible that the contact regions of the slab-shaped components of the first layer are covered by the slab-shaped components of the second layer. This enables a stiffer design of the entire building element. In addition, the windproofing of the building element is improved.

In a further preferred design embodiment, additional layers of slab-shaped components can also be provided. In particular, the slab-shaped components of the first, second and additional layers can comprise the same or different materials. Particularly preferably, the first layer comprises a wood or wood composite material, the second layer a soft wood fibre material and the additional layers a gypsum or fibrous gypsum material. In an alternative design embodiment, the first two layers comprise a wood or wood composite material, the second layer a soft wood fibre material and the additional layers a gypsum or fibrous gypsum material. This makes it possible to provide stable building elements with a high level of sound insulation. The fastening of the second and additional layers to the support structure is designed in such a manner that the fastening elements of the second layer engage through the first layer in the support structure and that the fastening elements of the second layer are spaced apart from the fastening elements of the first layer. The method of fastening the additional layers is similar to the method of fastening the second layer.

In a particularly preferred design embodiment, a second prefabrication installation is assigned to the covering station. The second prefabrication installation comprises a work table, a subtractive machining device, in particular a cutting, sawing and/or milling device, and a storage area for storing the slab-shaped components required for the operating step. In the second prefabrication installation, the slab-shaped components are configured in such a manner that necessary clearances and drill holes as well as pilot holes are already inserted into the slab-shaped components prior to positioning the slab-shaped components on the support structure. This makes it possible to provide a multiplicity of design variants of the building elements on a main production line.

A module integration station of the main production line is configured in such a manner that a slab-shaped component is deposited and fastened on the building element, wherein the slab-shaped component has a protruding component. The protruding components can be part of a shading system. In a preferred design embodiment, the module integration station is configured in such a manner that the slab-shaped component is deposited and fastened by a robot. In order to deposit the slab-shaped component on the building element at least approximately flat, a space and/or a clearance must be present and/or generated on the building element in the region of the protruding component. Before depositing the component, the clearance is preferably generated at the corresponding location by a subtractive machining step, in particular by means of milling. In an alternative generation of the clearance, the slab-shaped components are deposited and fastened on the support structure in the covering station in such a manner that a clearance, in particular the necessary clearance, is generated in the process.

The slab-shaped components preconfigured with the additional component are provided by a third prefabrication installation.

The third prefabrication installation has an assembly unit, a module conveyor unit and a module storage.

The assembly unit has a work table, a sawing unit, a lifting device and a region in which waste from the processing of the slab-shaped components is collected. In a preferred design embodiment, the lifting device has a robot. The robot is configured in such a manner that the position of the slab-shaped components on the work table can be altered.

The additional component is screwed, clamped, stapled and/or adhesively bonded to the slab-shaped component. For shading systems, the part can be a housing of a shading system, in particular for a roller shutter or a blind, a power cable and/or a data cable. After assembly, the slab-shaped components with the additional component are conveyed either directly to the respective processing device of the main production line or into the module storage. The module storage is connected to the assembly unit by way of a module conveyor unit. For this purpose, the module storage has storage locations for the slab-shaped components with the components protruding from the slab-shaped components. In a preferred design embodiment, the storage locations are configured as movable units, in particular as autonomous movable units, so that the storage locations can be moved to the processing device. The storage locations are preferably stocked in such a manner that the required slab-shaped components with the respective component are in stock for the respective method step of the production of the building elements on the main production line.

A turning station which is configured in such a manner that the building element is turned by preferably approximately 180° in such a manner that the support structure of the building element bears on the attached slab-shaped components on a work table and the cavity between the supporting elements is accessible. The turning station comprises a first work table which has a folding function, and a second work table which also has a folding function. The two work tables are mutually positioned in such a manner that the building element on the first folded-up work table is transferred to the second folded-up work table, so that the side of the support structure covered with the slab-shaped components points in the downward direction of the folding movement of the second work table.

The turning station comprises the following operating steps: Folding the first work table, wherein a building element to be turned, which is mounted on the work table, is moved from a horizontal position to an at least approximately vertical position. Folding the second work table from a horizontal position to an at least approximately vertical position in such a manner that the building element can be transferred from the first to the second work table. Transferring the building element from the first work table, which is approximately vertical, to the second work table, which is approximately vertical. Folding the second work table from the approximately vertical upright position to a horizontal position.

A filling station which is configured in such a manner so as to fill the cavity between the supporting elements of the building element with a filler material. In a preferred design embodiment, the building element has a multiplicity of cavities between the supporting elements, which are each separated from one another by a supporting element. The filling station has a filling device or a robot, in order to incorporate a filler material, and preferably a structural component, into the cavity of the building element. In some embodiments, a multiplicity of filling devices can be provided, the filling device being configured in such a manner that it can incorporate and distribute a suitable amount of a filler material within the cavity or cavities. Adjacent to the filling device, a blade can be provided with which the filler material is distributed in the cavity in such a manner that the surface of the filler material is substantially coplanar with the surface of the supporting elements, and/or excess filler material is removed from the surface. The filler material preferably comprises a free-flowing, injectable and/or insertable material, with which the cavity is to be filled, in particular to be completely filled. A free-flowing material is preferably understood to mean an inert bulk material, in particular plastics, and/or naturally produced free-flowing materials, such as split and/or perlite. A preferred injectable material comprises a foam, in particular a plastic foam, which, depending on the type of foam, has a downstream curing station and/or a drying station. It is particularly advantageous that foams can fill the cavity completely in a simple manner. In addition, foams have a high content of air pockets, this providing good sound insulation, and heat and/or cold protection. Insertable materials preferably comprise materials in mat form, comprising a fibrous or expanded foam material. The mat-shaped material is processed in a fourth prefabrication installation of the filling station in such a manner that one or a multiplicity of mats fill the cavity at least partially, in particular completely.

In a preferred designed embodiment, a structural component is introduced prior to the incorporation of the filler material. The structural component has a three-dimensional structure, in particular a structure having in top view in particular a lattice, a rectangular, a diamond, a circular and/or a honeycomb structure of webs and/or struts, which in a preferred design embodiment form chambers into which the filler material is incorporated. The structural component serves to distribute the filler material and keeps the filler material at least approximately in position. The structural component is inserted into the cavity and fixed if required. In a movable insertion of the structural component into the cavity, the structural component is held at least approximately in position by incorporating the filler material in the cavity, in that the filler material is distributed about the structural component and between the supporting elements. Alternatively, the structural component can be fastened to the supporting elements as well as to the slab-shaped components facing the structural component. The fastening preferably comprises a friction-fitting and form-fitting fastening, in particular a clamping connection of the component, or a threaded connection, a rivet connection and/or a snap-fitting connection.

A fourth prefabrication installation is assigned to the filling station. In the fourth prefabrication installation, a mat-shaped filler material and/or an insertable structural component are/is processed. The fourth prefabrication installation has a work table with a processing device, a lifting device and a region in which waste from the processing of the slab-shaped components is collected. In a preferred design embodiment, the processing device can be a cutting and/or sawing device. The lifting device preferably has a robot to alter the position of the slab-shaped components. The processed mat-shaped filler materials and/or the structural components are fed to the processing device of the filling station of the main production line by way of a conveyor unit.

An additional covering station, which is configured to position a multiplicity of slab-shaped components, that are provided to the station by way of a transport device and/or a storage area, above an outer surface of the support structure, in particular to position them in such a manner that the slabs at least approximately correspond in one dimension to the dimension of the support structure or are placed in a predetermined pattern and cover the in particular filled cavity. The covering station is furthermore configured in such a manner so as to at least temporarily fasten the slab-shaped components to the support structure using a multiplicity of fastening elements, wherein the fastening elements are positioned in such a manner that they engage in the support structure. In a preferred embodiment, the covering station is configured in such a manner that an additional layer of slab-shaped components is positioned and deposited on an already fastened layer of slab-shaped components. The slab-shaped components are preconfigured in such a manner that they have at least approximately the same dimensions as the slab-shaped components of the first layer. In a particularly preferred embodiment, the slab-shaped components of the second layer have dimensions which differ from the slab-shaped components of the first layer. In another alternative embodiment, the slab-shaped components of the second layer are deposited and fastened in a different position to the first layer. This makes it possible to cover the contact regions of the slab-shaped components of the first layer with the slab-shaped components of the second layer. This results in a stiffer design embodiment of the building element.

In a further preferred design embodiment, additional layers of slab-shaped components can also be provided. In particular, the slab-shaped components of the first, the second and the additional layer can consist of the same or of different materials. The fastening of the second and additional layers to the support structure is designed in such a manner that the fastening elements of the second layer engage through the first layer in the support structure and that the fastening elements of the second layer are spaced apart from the fastening elements of the first layer. The method of fastening the additional layers is similar to the method of fastening the second layer.

In a preferred further method step, a building element is divided into a plurality of parts in a separation station, each of which parts can be used as a separate building element, wherein at least one upper and one lower supporting element extend over the entire length of the unseparated building element. In a particularly preferred embodiment, the building element is divided at a predefined and marked separation point by a subtractive machining device. Preferably, the region of the separation point has no slab-shaped components in at least some regions. The subtractive machining device preferably comprises a milling, sawing and/or cutting device, in particular a fully automated sawing and/or cutting device. Preferably, the building element is divided into a multiplicity of building elements which are of the same type and/or associated.

The maximum size of the building elements to be produced is approximately limited to the work table size of the individual stations, whereby the shortest work table of the main production line at least approximately defines the maximum length of a building element. The dimensions of the building elements required for the construction site are determined by the planned building construction, which usually produces a large number of building elements with shorter lengths than the maximum possible length. This makes it possible to produce a plurality of comparatively short building elements simultaneously on one work table. The determination of the building elements to be generated simultaneously on one work table can be done manually and/or with the help of a computer program, in particular with the help of a simulation. By producing a plurality of building elements on one work table in one operation, it is possible to make the best possible use of the work table length. This makes it possible to provide a particularly flexible main production line with a high utilization rate.

In a further preferred method step, the building element is erected vertically with the aid of an erection device and conveyed to a further processing station. In the further processing station, an additional layer, preferably a weather-resistant layer, is attached to the building element. The processing station has a plurality of working areas, in particular two superimposed working areas, in order to dispose an additional layer on at least one side of the building element, in particular to fasten said additional layer thereto. In a preferred embodiment, the additional layer comprises a water-repellent plaster, a wooden cladding with a multiplicity of wooden slats and/or a veneer system comprising a plurality of individual veneer panels. The additional layer can be attached manually, partially manually or fully automatically, in particular by a robot. Subsequently, the building element is conveyed to another processing station and/or a storage.

A building element storage is provided as the last station of the main production line. The building element storage is connected to the previous station by way of a conveyor unit in such a manner that the conveyor unit transports the building elements from the previous station to the building element storage. The building element storage is populated with the generated building elements in such a manner that the loading of a transport unit, in particular a commercial vehicle, which transports the building elements to a construction site for the assembly of a building, takes place in the order in which the building elements are built up on the construction site. In particular, the individual floors of a building are combined in one area in the building element storage and stored until transported to the construction site.

The manufacturing plant comprises a second prefabrication line for processing slab-shaped components. The second prefabrication line comprises a first storage of slab-shaped components, a slab cutting device for processing the slab-shaped components and a second storage for at least temporarily storing the processed slab-shaped components, the first storage and the second storage being positioned and in particular designed in such a manner that they can be approached from three sides by a conveyor. The second prefabrication line comprises a first conveyor between the first storage and the slab cutting device, and a further conveyor between the slab cutting device and the second storage. The slab cutting device comprises a subtractive machining device, in particular a milling, a sawing and/or a cutting device, for processing slab-shaped components. The second storage has a robot for sorting and storing the processed slab-shaped components. The storage in the second storage is carried out in such a manner that the processed slab-shaped components are sorted according to material, according to size and/or according to a clearance individually inserted in the slab-shaped components. In a preferred design embodiment, a slab-shaped component can be processed on the slab cutting device of the second prefabrication line, while a building element is simultaneously processed on a station of the main production line, wherein the slab-shaped component processed in the second prefabrication line is supplied to the covering station or the additional covering station of the main production line.

The first, second, third and fourth prefabrication installations are presently combined so as to form the first prefabrication line.

Further important features and advantages of the invention are derived from the dependent claims, from the drawings and from the associated description of the figures.

It goes without saying that the features mentioned above and yet to be explained hereunder can be used not only in the respectively stated combination, but also in other combinations or in isolation, without departing from the scope of the present invention. In particular, different combinations or repetitions of individual stations of the main production line and the prefabrication lines can be used.

Preferred exemplary embodiments of the invention are illustrated in the drawings and will be explained in more detail in the following description, wherein the same reference signs refer to the same or similar or functionally equivalent components.

In the figures:

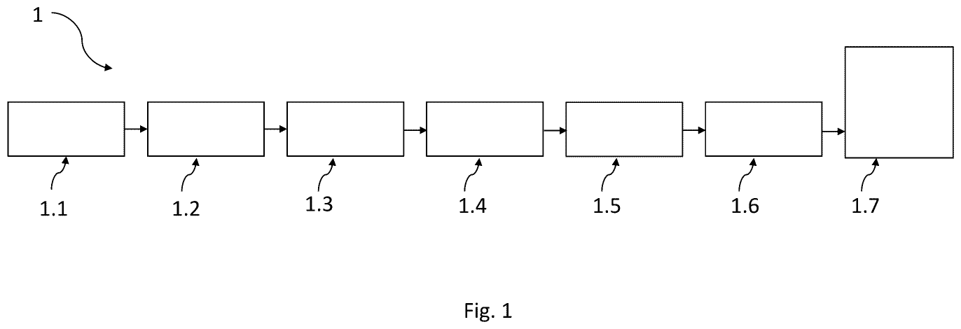

FIG. 1 shows a schematic diagram of the main production line of a manufacturing plant according to the invention;

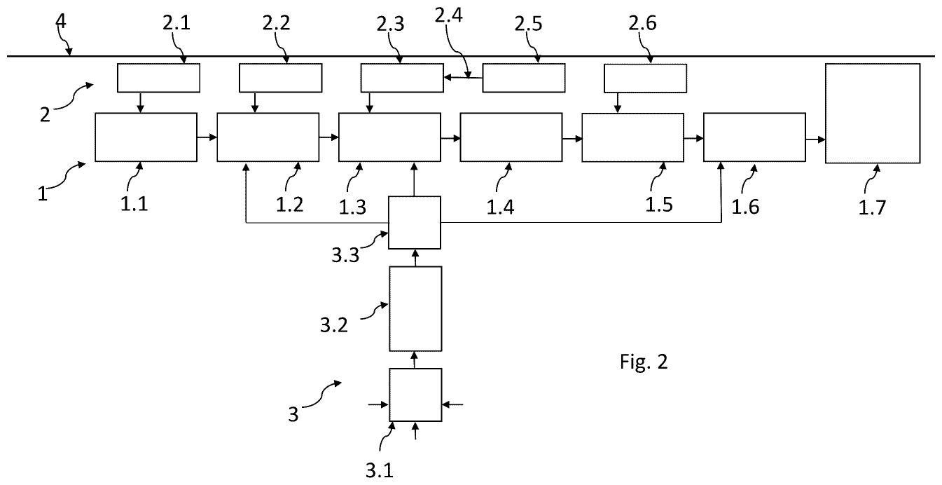

FIG. 2 shows a schematic diagram of the manufacturing plant with a main production line and associated prefabrication installations (or lines);

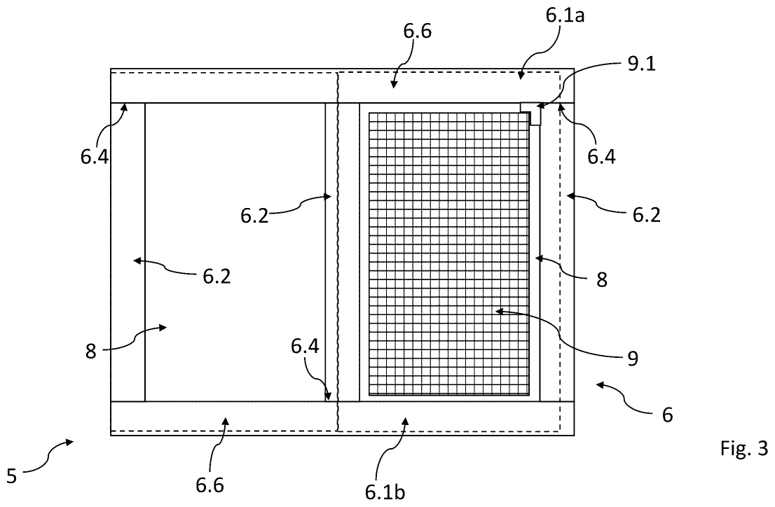

FIG. 3 shows a schematic diagram of a building element comprising a structural component;

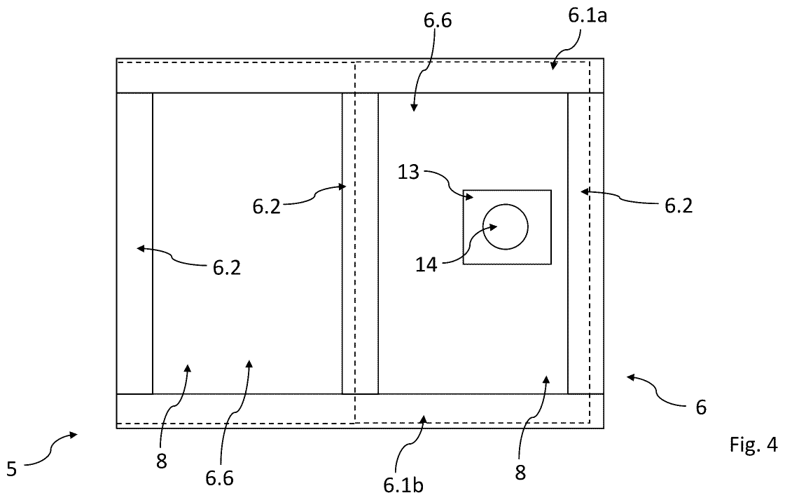

FIG. 4 shows a schematic diagram of a building element comprising an additional component;

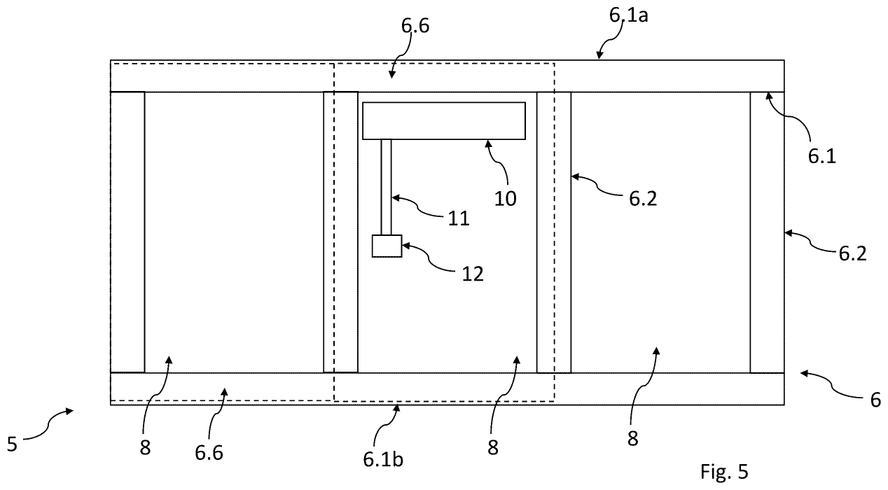

FIG. 5 shows a schematic diagram of a building element comprising an alternative additional component; and

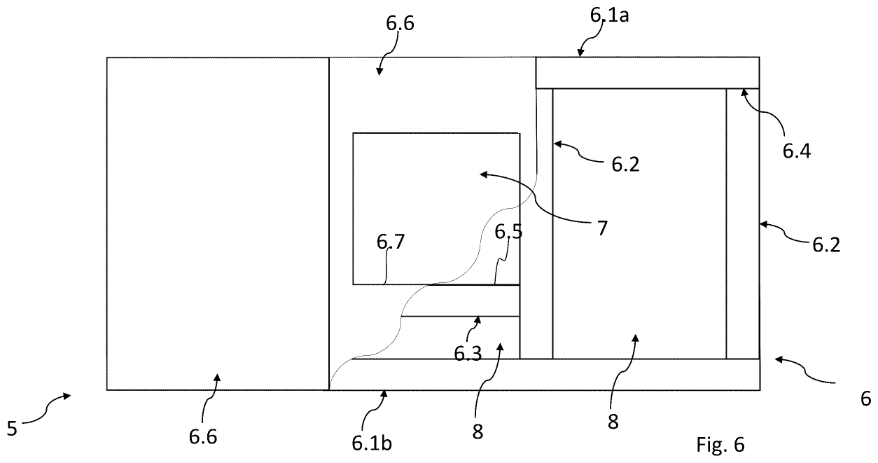

FIG. 6 shows a schematic diagram of a building element comprising a clearance.

Shown in FIG. 1 is an embodiment of a manufacturing plant for producing multi-part building elements 5 in a schematic illustration. The manufacturing plant comprises one main production line 1 and can comprise a plurality of prefabrication lines 2, 3. The main production line 1 has a multiplicity of production stations. The individual production stations are disposed in a row behind one another, according to the logic of the production steps. An arrangement in a row leads to an efficient main production line 1, as unnecessary transport routes of a building element 5 to be produced can be avoided. Conveyor units, in particular transfer units, are provided between the individual stations. In an alternative design embodiment, the individual stations are mutually disposed in such a manner that a building element 5 to be produced can be transferred from one station directly to another station, wherein the building element 5 to be produced has a greater longitudinal extent than the largest spacing between two production stations.

The production stations of the manufacturing plant comprise a support frame station 1.1, a covering station 1.2, a module integration station 1.3, a turning station 1.4, a filling station 1.5, an additional covering station 1.6 and a storage 1.7.

The support structure station 1.1 has a work table, a feed unit for the supporting elements 6.1, 6.2, 6.3, a gantry crane, a robot, a device for positioning the supporting elements, and a fastening device for fastening the supporting elements to one another. The supporting elements 6.1, 6.2, 6.3 are conveyed to the work table and/or deposited by the feed unit and/or the gantry crane in such a manner that a support structure 6 for the building element 5 is created. In particular, the support structure 6 is generated in such a manner that an upper supporting element 6.1a and a lower supporting element 6.1b are deposited on the work table, wherein the upper supporting element 6.1a and the lower supporting element 6.1b define the upper and lower edge of the building element 5 to be generated. Between the upper and lower supporting elements, further supporting elements 6.2, 6.3 are disposed on the work table in such a manner that a support structure 6 for the building element 5 is formed, wherein the support structure 6 has in particular one or a plurality of clearances 7. The clearances 7 are designed in such a manner that windows, doors or the like can be installed in the building element 5. The supporting elements 6.1, 6.2, 6.3 can be mutually aligned with a positioning device. They are fastened to one another with a processing device in such a manner that a support structure 6 is created. Subsequently, the support structure 6 is conveyed from the support structure station 1.1 to a subsequent station, in particular to the covering station 1.2.

The covering station 1.2 has a work table, a storage area for storing the slab-shaped components 6.6 required for the operating step, a robot and a fastening device. The robot positions the slab-shaped components 6.6 in such a manner that the support structure 6 is at least partially covered with the slab-shaped components 6.6. After placing the slab-shaped components 6.6 on the support structure 6, the slab-shaped components 6.6 are fastened to the supporting elements 6.1, 6.2, 6.3 with the aid of the device. The fastening elements comprise nails, screws, wire clips and/or comparable fasteners. In a preferred design embodiment, after fastening a first layer of slab-shaped components 6.6 with the aid of the robot, an additional layer of slab-shaped components 6.6 is deposited on the first layer of slab-shaped components 6.6. Subsequently, the slab-shaped components 6.6 of the second and of the additional layer are fastened to the supporting elements 6.1, 6.2, 6.3 by means of the fastening device in such a manner that the fastening elements of the first layer of the slab-shaped components 6.6 are spaced apart from the fastening elements of the additional layer. Subsequently, the building element 5 is conveyed from the covering station 1.2 to a subsequent station, in particular to the module integration station 1.3.

The module integration station 1.3 has a work table, a storage area, a subtractive machining device, in particular a milling device, a robot and a fastening device. The storage area comprises the slab-shaped components 6.6 required for the operating step, wherein the slab-shaped components 6.6 are positioned on a multiplicity of stacks in the region of the work table. The storage area has both standardized slab-shaped components 6.6 and slab-shaped components having an additional (protruding) component. In one exemplary design embodiment, the subtractive machining device generates a clearance, preferably a groove, in the uppermost layer of the slab-shaped components 6.6 which are deposited on the support structure 6 of the building element 5. Subsequently, an additional layer of slab-shaped components 6.6 is deposited on the building element 5 with the aid of a robot in such a manner that a protruding additional component 10, 11, 12, 13, 14, which is disposed on one of the pre-assembled slab-shaped components 6.6, engages in the clearance. After depositing the slab-shaped components 6.6 on the building element 5, the individual slab-shaped components 6.6 are fastened to the supporting elements 6.1, 6.2, 6.3 with the aid of the device. Nails, screws, wire clips and/or a comparable fastening element can be used as fastening elements. Subsequently, the building element 5 is conveyed from the module integration station 1.3 to a subsequent station, in particular to the turning station 1.4.

The turning station 1.4, which is configured in such a manner that the building element 5 is turned by at least approximately 180° in such a manner that the support structure 6 of the building element 5 on the slab-shaped components 6.6 fastened thereto bears on a work table in order to render the space 8 between the supporting elements 6.1, 6.2, 6.3 accessible. The turning station 1.4 comprises a first work table which has a folding function, and a second work table which also has a folding function. The two work tables are mutually positioned in such a manner that the building element 5 on the first folded-up work table is transferred to the second folded-up work table, so that the side of the support structure 6 covered with the slab-shaped components 6.6 points in the downward direction of the folding movement of the second work table.

The turning station 1.4 comprises the following operating steps: Folding the first work table, having the building element 5 to be turned, from a horizontal position to an at least approximately vertically upright position. Folding the second work table from a horizontal position to an at least approximately vertically upright position in such a manner that the building element 5 can be transferred from the first to the second work table. Transferring the building element 5 from the first work table to the second work table. Folding the second work table from the approximately vertically upright position to a horizontal position. Subsequently, the building element 5 is conveyed from the turning station 1.4 to a subsequent station, in particular to the filling station 1.5.

The filling station 1.5 has a work table, at least one filling device and/or a robot for filling. The filling device has an infeed of the filler material from a filler material storage. When using a multiplicity of filler materials, the filling device has a multiplicity of filler material storages. The filler material comprises a free-flowing, injectable and/or insertable material to fill the space 8. In the case of a free-flowing filler material, the filler material storage comprises a silo. The filler material is fed by way of a bulk material conveyor, in particular a belt conveyor. In the case of an injectable filler material, the infeed comprises an air conveyor device, in particular a turbine, which generates an air flow, and a pipeline system, in particular a pipeline system which can at least be partially flexibly moved. In the case of an insertable filler material, the infeed comprises a robot having an arm for gripping the insertable filler material from a storage system. In a particular design embodiment, the filling device can have a blade to homogenize the surface of the filler material and to remove excess filler material.

In a preferred design embodiment, a structural component 9 is inserted into the space 8 prior to filling. The structural component 9 can be deposited loosely in the space 8 on the slab-shaped component 6.6, or be fastened to the slab-shaped component 6.6 and/or the supporting elements 6.1, 6.2, 6.3. When the structural component 9 is fastened to the slab-shaped components 6.6 and/or the supporting elements 6.1, 6.2, 6.3, it additionally reinforces the building element 5. In particular, with highly loaded building elements 5, such additional reinforcing can be necessary to distribute and transmit the forces acting on the building element 5 uniformly.

The structural component 9 further serves to improve the distribution of the filler material within the space 8, or divides the space 8 into two or more spaces. In a particularly preferred design embodiment, the structural component 9 has a three-dimensional structure with a plurality of struts and/or webs, in particular in top view in the form of a plurality of circles, rectangles and/or honeycombs, wherein the space 8 is divided into a plurality of chambers. In studies it has been demonstrated that particularly free-flowing filler material can be distributed particularly uniformly amongst the chambers of the structural component 9. The filler material located in the chambers is held at least approximately in position by way of the chamber walls, whereby a displacement of the centre of mass of the building element 5 is reduced or avoided.

The filling station 1.5 is configured in such a manner that the space 8 between the supporting elements 6.1, 6.2, 6.3 of the building element 5 is filled with a filler material. In a preferred design embodiment, the building element 5 has a plurality of spaces 8 between the supporting elements 6.1, 6.2, 6.3, which are each separated from one another by a supporting element 6.1, 6.2, 6.3. The filling device is configured in such a manner that it distributes a suitable amount of a filler material within the space 8 or the spaces 8 and, in particular, by way of the blade, homogenizes the filler material in the spaces 8 and removes excess material. Subsequently, the building element 5 is conveyed from the filling station 1.5 to a subsequent station, in particular to the additional covering station 1.6.

The additional covering station 1.6 has a work table, a storage area, for storing the slab-shaped components 6.6 required for the operating step, a robot and a fastening device. The support structure 6 is covered by a robot with slab-shaped components 6.6, which are provided by way of the storage area. The robot positions the slab-shaped components 6.6 in such a manner that the spaces 8 of the support structure 6 filled with filler material are covered. After depositing the slab-shaped components 6.6 on the support structure 6, the slab-shaped components 6.6 are fastened to the supporting elements 6.1, 6.2, 6.3 with the aid of the fastening device. The fastening elements comprise nails, screws, wire clips, adhesives and/or a comparable fastening element. In a preferred design embodiment, after fastening the first layer of slab-shaped components 6.6 with the aid of the robot, an additional layer of slab-shaped components 6.6 is deposited on the first layer of slab-shaped components 6.6. Subsequently, the slab-shaped components 6.6 of the second layer are fastened to the supporting elements 6.1, 6.2, 6.3 by means of the fastening device in such a manner that the fastening elements of the first layer of the slab-shaped components 6.6 are spaced apart from the fastening elements of the second layer. Subsequently, the building element 5 is conveyed from the additional covering station 1.6 to a subsequent station, in particular into the building element storage 1.7.

The building element storage 1.7 has a conveyor unit, a storage area comprising a plurality of storage locations for the building elements 5 and a further conveyor unit, in particular an overhead crane unit. The conveyor unit is connected to the previous station in such a manner that the conveyor unit transports the building elements 5 from the previous station to the storage, in particular autonomously. The storage area is populated with the generated building elements 5 in such a manner that the loading of a transport unit, in particular a commercial vehicle, which transports the building elements 5 to a construction site for the assembly of a building, takes place in the order in which the building elements 5 are built up on the construction site. The transport unit is loaded by way of the additional conveyor unit, in particular by way of an overhead crane.

FIG. 2 shows in a schematic illustration an embodiment of the inventive manufacturing plant with a main production line 1 and a selection of prefabrication installations, which together form a first prefabrication line 2, in relation to a supporting structure of a factory shed 4, and a second prefabrication line 3.

The first prefabrication line 2 has an assembly unit (2.3c) for processing slab-shaped components (6.6), and a conveyor unit for feeding the processed slab-shaped components (6.6) to the main production line (1). In a preferred embodiment, the first prefabrication line 2 has a module storage (2.3a). This is operated in reverse order for removal for a downstream processing step. Preferably, the assembly unit (2.3c) comprises a subtractive machining device, in particular a milling, sawing and/or cutting device, for adjusting the dimensions or for generating clearances in a slab-shaped component (6.6). Furthermore, the assembly unit (2.3c) can comprise a processing device for attaching a component to a slab-shaped component. The components can comprise a part of a shading system. Preferably, the part of the shading system comprises a housing for a roller shutter or a blind, a power cable and/or a data cable for supplying and/or actuating the shading system.

The first prefabrication line 2 is disposed parallel to the main production line 1 and between the main production line 1 and a supporting structure of a factory shed 4. The first prefabrication line 2 comprises a first prefabrication installation 2.1, which is assigned to the support structure station 1.1, a second prefabrication installation 2.2, which is assigned to the covering station 1.2, a third prefabrication installation 2.3, which is assigned to the module integration station 1.3, and a fourth prefabrication installation 2.4, which is assigned to the filling station 1.5 of the main production line 1.

The first prefabrication installation 2.1 serves to process supporting elements 6.1, 6.2, 6.3, in order to prepare them for further processing at the support structure station. The first prefabrication installation 2.1 comprises a work table, a subtractive machining device, in particular a sawing, milling and/or cutting device, and a conveyor unit for transporting processed supporting elements 6.1, 6.2, 6.3 to the support structure station 1.1 of the main production line 1. The supporting elements 6.1, 6.2, 6.3 are positioned on the work table of the first prefabrication installation 2.1 and shortened to the corresponding length of the support structure 6 to be produced on the main production line 1. In a preferred embodiment, the supporting elements 6.1, 6.2, 6.3 are machined with a further subtractive machining device, in particular a planing device, in such a manner that at least one of the two further dimensions of the supporting elements 6.1, 6.2, 6.3, in particular the height and/or width, are/is adapted to the corresponding dimension of the further supporting elements 6.1, 6.2, 6.3 of the support structure 6 to be produced. Particularly preferably, the first prefabrication installation 2.1 has a further subtractive machining device, in particular a milling device, to produce receptacles, in particular grooves and/or pins, on the supporting elements 6.1, 6.2, 6.3. With the aid of the generated receptacles, the supporting elements 6.1, 6.2, 6.3 can be easily joined together in the support structure station 1.1 of the main production line 1 in order to provide the support structure 6. By providing supporting elements 6.1, 6.2, 6.3, which have grooves and pins, assembling the support structure is particularly easy since the individual connection points 6.4 are predefined by the grooves and pins on the supporting elements 6.1, 6.2, 6.3. Downstream, the processed supporting elements 6.1, 6.2, 6.3 are conveyed to the support structure station 1.1 of the main production line 1 for further processing with the aid of the conveyor unit.

The second prefabrication installation 2.2 serves to process slab-shaped components 6.6 in order to prepare them for further processing at the covering station 1.2 of the main production line 1. The second prefabrication installation 2.2 has a work table, a processing device, in particular a subtractive machining device for slab-shaped components 6.6. The processing device is preferably a cutting, milling or sawing device. In the second prefabrication installation 2.2, the slab-shaped components 6.6 are configured in such a manner that necessary clearances 7 and bores as well as pilot holes are introduced into the slab-shaped components 6.6 already prior to positioning the slab-shaped components 6.6 on the support structure 6. This makes it possible to provide a multiplicity of design variants of the building elements 5 on a main production line 1.

The third prefabrication installation 2.3 comprises an assembly unit 2.3c, a module conveyor unit 2.3b and a module storage 2.3a. The assembly unit 2.3c has a work table, in particular a rotary table, a subtractive machining device, in particular a cutting, milling or sawing unit, a lifting device, in particular a robot, for altering the position of the slab-shaped components 6.6, a fastening device for fastening additional components 10, 11, 12, 13, 14 to the slab-shaped components 6.6, and a region for collecting waste from the machining of the slab-shaped components 6.6. In the assembly unit 2.3c, the slab-shaped components 6.6 are configured to the dimensions required for further processing in the module integration station 1.3 of the main production line 1. Subsequently, another component 10, 11, 12, 13, 14, which can be a part of a shading system, is fastened to the slab-shaped component. The fastening can be performed by means of a threaded connection, a clamping connection, a stapled connection, an adhesively bonded connection, or with the aid of another component. Subsequently, the processed slab-shaped component 6.6 is conveyed by way of the module conveyor unit 2.3b into the module storage 2.3a, or directly to the module integration station 1.3 of the main production line 1.

In the fourth prefabrication installation 2.4, a mat-shaped filler material and/or an insertable structural component 9 is processed. The fourth prefabrication installation 2.4 has a work table with a processing device, in particular a cutting and/or sawing device, a lifting device, in particular a robot, to alter the position of the slab-shaped components 6.6, and a region to collect waste from the processing of the slab-shaped components 6.6. The processed mat-shaped filler materials and/or the structural components 9 are fed to the filling station 1.5 of the main production line 1 by way of a conveyor unit, in particular an autonomous conveyor unit, in particular in such a manner that the building element 5 to be processed on the work table of the filling station 1.5 is provided with the corresponding materials and/or components of the fourth prefabrication installation 2.4.

A second prefabrication line 3 has a first storage 3.1, a slab cutting device 3.2 and a second storage 3.3. The slab cutting device 3.2 comprises, in an alternative, a milling, a sawing and/or a cutting device to carry out the configuration of the slab-shaped components 6.6 to be processed. The first storage 3.1, the slab cutting device 3.2 and the second storage 3.3 are disposed in a line behind one another. The second prefabrication line 3 is disposed almost orthogonally in relation to the main production line 1. In an alternative, the second prefabrication line 3 is moreover disposed on the opposite side of the main production line 1 in terms of the first prefabrication line (2). A conveyor unit, in particular an autonomous conveyor unit, is provided between the second storage 3.3 of the second prefabrication line 3 and the processing devices of the main production line 1. Hereby, a particularly flexible integration of a second prefabrication line 3 is possible, since both the first storage 3.1 as well as the second storage 3.3 can be operated from a plurality of sides, whereby the processed slab-shaped components 6.6 from the second storage 3.3 can be, in particular simultaneously, conveyed by a plurality of conveyor units to a plurality of processing devices of the main production line 1, in particular be conveyed in such a manner that the individual transport routes from the second prefabrication line 3 to the processing devices of the main production line 1 can be optimized. Thus, fast conveying of the slab-shaped components 6.6 can be ensured.

FIG. 3 shows a schematic illustration of a building element 5 with a support structure 6. The support structure 6 has an upper supporting element 6.1 and a lower supporting element 6.1. Vertical supporting elements 6.2 are disposed almost orthogonally between the upper and lower supporting elements 6.1. In the contact region of the supporting elements 6.1, 6.2, a connection point 6.4 is provided for each contact region. The mutual connection points 6.4 of the supporting elements 6.1, 6.2 can each have a tongue-and-groove system. The supporting elements 6.1, 6.2 are mutually positioned and fastened in the region of the connection points 6.4. In a preferred design embodiment, the connection point 6.4 has a tongue-and-groove connection. This makes it possible to assemble the support structure 6 easily. In addition, the tongue-and-groove connection leads to a further reinforcement of the support structure 6, since the supporting elements 6.1, 6.2 engage in the area of the connection point 6.4.

FIG. 3 furthermore illustrates slab-shaped components 6.6. The slab-shaped components 6.6 are disposed in the view behind the supporting elements 6.1, 6.2. The slab-shaped components 6.6 are positioned relative to the supporting elements 6.1, 6.2 in such a manner that a space 8 between the supporting elements 6.1, 6.2 is covered on one side. Furthermore, the slab-shaped components 6.6 are positioned in such a manner that the slab-shaped components 6.6 terminate at least approximately flush with the upper and lower supporting elements 6.1. The slab-shaped components 6.6 are mutually positioned in such a manner that the slab-shaped components 6.6 are in contact with one another by means of an edge, or at least adjacent to one another, in order to form a flat layer of slab-shaped components 6.6. The edges of the slab-shaped components 6.6 are aligned at least approximately centrally to a vertical supporting element 6.2, whereby it can be ensured that the adjacent slab-shaped components 6.6 can be fastened to the vertical supporting element 6.2.

Furthermore, FIG. 3 shows a structural component 9 which can be positioned in the space 8 between the supporting elements 6.1, 6.2 on a slab-shaped component 6.6. The structural component 9 has in one embodiment a three-dimensional structure, at least in the form of a web or a strut. The web or strut divides the space 8 into two spaces, which allows further reinforcing of the support structure 6. In an alternative embodiment, the structural component 9 is a three-dimensional structure with individual chambers. The individual chambers of the structural component 9 are separated from one another by way of webs. The chambers have a lattice structure in their top view. In an alternative design embodiment, the chambers have a diamond, circular or honeycomb structure in their top view. The structural component 9 is inherently reinforced by the chambers, whereby a particularly stiff building element 5 can be provided.

The structural component 9 can be inserted into the space 8 with an exact fit, or at a spacing from the adjacent supporting elements 6.1, 6.2. When the structural component 9 is incorporated with an exact fit, the space 8 can be optimally utilized for the reinforcement by the structural component 9. The structural component can also be fastened to the slab-shaped component 6.6 and/or to the supporting elements 6.1, 6.2 in order to further improve a potential force transmission.

When incorporating the structural component 9 with a spacing from the supporting elements 6.1, 6.2, the structural component can be held in position by a subsequently introduced filler material, or the structural component is fastened by means of fastening means to the slab-shaped component 6.6 or the supporting elements 6.1, 6.2. In order to provide a particularly stiff building element 5, the structural component 9 can be fastened to the supporting elements 6.1, 6.2 with the aid of adapter pieces 9.1 in such a manner that a force transmission from the structural component 9 to the supporting elements 6.1, 6.2 is possible, despite there being a spacing between the structural component 9 and the supporting elements 6.1, 6.2.

In a downstream step, the space 8 is filled with a filler material. The space 8 can be equipped for this purpose with or without a structural component 9. In FIG. 3, a space 8 without a structural component 9 is shown on the left side, and with a view to the figure on the right side, a space 8 with a structural component 9 is shown. The filler material is distributed in the space 8 by the structural component 9. The filler material is distributed in the chambers of the structural component 9. The filler material is held at least approximately in position in the chambers, whereby a displacement of the centre of mass of the building element 5 during transport is reduced or completely avoided. The chambers moreover lead to less freedom of movement of the filler material, which means that the filler material has less settling and/or abrasion. This preserves the original uniform distribution of the filler material over the useful life of the building element 5, which provides a good sound insulation, and heat and/or cold protection over the long term. Further advantages in the use of a structural component 9 arise in the use of the building element 5, since potential damage to the building element 5 is limited to the respective damaged chambers of the structural component 9. Thus, it is possible to repair a damaged building element 5 in a simple way in the region of the damaged chambers in such a manner that the original state can be restored. This advantage is particularly pronounced when a free-flowing filler material is used as the filler material, as only the filler material of the damaged chambers must be repaired.

FIG. 4 discloses a building element 5 having a support structure 6 having an upper and a lower supporting element 6.1. Disposed between the upper and lower supporting elements 6.1 are vertical supporting elements 6.2, whereby spaces 8 are formed between the supporting elements 6.1, 6.2. The building element 5 can be a wall, floor, ceiling or roof element of a building. The building element 5 further comprises slab-shaped components 6.6, which are disposed in the view of FIG. 4 behind the supporting elements 6.1, 6.2. The slab-shaped components 6.6 are positioned and fastened on the support structure 6 in such a manner that the support structure 6 is at least partially covered.

The slab-shaped components 6.6 can have an additional component 13. The additional component 13 is attached to the slab-shaped components 6.6 in a third prefabrication installation 2.3. This additional component 13 protrudes from the slab-shaped component 6.6 and engages in the space 8 between the supporting elements 6.1, 6.2. In one variant, the additional component 13 is a sleeve carrier 13 with an opening 14. The sleeve carrier 13 is positioned on the slab-shaped component 6.6 in such a manner that at least the opening 14 of the sleeve carrier is at least approximately co-aligned with a clearance in the slab-shaped component 6.6. The sleeve carrier 13 can be fastened to the slab-shaped component 6.6 with the aid of a separate fastening means or by means of a press-fit. In one variant, a pipe and/or a cable can be routed through the opening 14 of the sleeve carrier 13. In a special variant, the cable is a power and/or data cable for supplying and/or actuating a shading system. In an alternative variant, the sleeve carrier 13 has a strong heat-insulating material in order to protect the building element 5 as opposed to a retrofitted exhaust pipe against damage, in particular increased heat radiation.

In one design embodiment, the space 8 can have a structural component 9. This is disposed about the additional component 13 in order to reinforce the building element 5. The space 8 is filled with a filler material. The filler material can be used to meet the required fire protection, sound insulation, and heat and/or cold protection for the building element 5.

FIG. 5 discloses a building element 5 having a support structure 6 having an upper and a lower supporting element 6.1. A plurality of vertical supporting elements 6.2 are disposed between the upper and lower supporting elements 6.1 in such a manner that the support structure 6 is created. The support structure 6 is at least partially covered with slab-shaped components 6.6, which are disposed in top view behind the supporting elements 6.1, 6.2. The slab-shaped components 6.6 are positioned on the support structure 6 in such a manner that the slab-shaped components 6.6 terminate at least approximately flush with the upper and/or lower supporting element 6.1. A slab-shaped component 6.6 has a plurality of additional components 10, 11, 12 which are fastened, in particular screwed, clamped, pressed, adhesively bonded, nailed, to the slab-shaped component 6.6 in such a manner that the additional component 10, 11, 12 protrudes into a space 8 between the supporting elements 6.1, 6.2. In one design embodiment, the additional components are a part of a shading system, in particular a housing of a roller shutter or a blind 10, an empty tube 11 and a cavity wall box 12 for a control module. The individual components 10, 11, 12 are disposed next to one another in such a manner that a connection from the housing 10 by way of the empty tube 11 to the cavity wall box 12 is present. In one variant, a cable is also provided, which leads from the housing 10 through the empty tube 11 to the cavity wall box 12. In a modified exemplary embodiment not shown, further components, such as a junction box, can be attached to the slab-shaped component so as to be able to connect a plurality of cables of the shading system in a simple manner. In an alternative design embodiment, a cable between the housing 10 and the cavity wall box 12 can be subsequently installed on the building site by way of the empty tube 11 in such a manner that the cable is pulled from the housing 10 through the empty tube 11 to the cavity wall box 12, or in reverse order. This makes it possible to provide a building element 5 which can either already be supplied with a cable to the construction site, or a cable can be easily introduced into the building element 5 on the construction site.

FIG. 6 shows a schematically illustrated building element 5. The building element 5 has a support structure 6. The support structure 6 comprises a plurality of supporting elements 6.1, 6.2, 6.3, in particular support beams. The supporting elements 6.1, 6.2, 6.3 can comprise a material of a renewable raw material, in particular wood and wood-based materials, wood composites, plastics, metals or another material preferred for the characteristic as a supporting element 6.1, 6.2, 6.3. In a particularly preferred design embodiment, the supporting element 6.1, 6.2, 6.3 comprises a sandwich construction having a layer of a material of a renewable raw material and a layer of a plastic, in particular a recycled plastic and/or a mixture of a plastic and a wood fibre material.

The support structure 6 has an upper supporting element 6.1, which represents an upper end of the building element 5, and a lower supporting element 6.1, which represents a lower end of the building element 5. Disposed between the upper and lower supporting elements 6.1 are additional vertically disposed supporting elements 6.2, each so as to be almost orthogonal. The respective supporting elements 6.1, 6.2 have a connection point 6.4 in the mutual contact region. In the region of the connection point 6.4, the supporting elements 6.1, 6.2 are connected by means of a fastening means. In a particularly preferred design embodiment, the supporting elements 6.1, 6.2, 6.3 can have a tongue-and-groove connection in the region of the connection points 6.4, to simplify the installation of the supporting elements 6.1 and enable a higher force transmission. In a further exemplary embodiment not shown, the connection point 6.4 of the supporting elements 6.1 is formed as a pin-to-pin hole connection. FIG. 6 furthermore shows another internal supporting element 6.3, which is disposed almost orthogonally between two vertical supporting elements 6.2 in such a manner that a clearance 7 in the support structure 6 is formed by the supporting elements 6.1, 6.2, 6.3. The clearance 7 can be used to receive a door, a window and/or an additional component. The supporting elements 6.1, 6.2, 6.3 reinforce the support structure 6 about the clearance 7 in such a manner that a door, a window and/or another component can be fastened to the supporting elements 6.1, 6.2, 6.3.

Furthermore, FIG. 6 discloses a slab-shaped component 6.6. The slab-shaped component 6.6 is positioned and deposited on the support structure 6 in such a manner that the slab-shaped component 6.6 terminates so as to be at least approximately flush with the upper and lower supporting elements 6.1. In a preferred embodiment, the slab-shaped component 6.6 terminates by way of an undersize in relation to the supporting elements 6.1. By depositing a slab-shaped component 6.6 adapted to the support structure 6, further post-processing measures, such as in particular the subsequent adjustment of the slab-shaped components 6.6 to the dimension of the support structure 6, can be reduced or in very special cases completely dispensed with.

The slab-shaped component 6.6 furthermore has an edge 6.7. The slab-shaped component 6.6 is deposited on the support structure 6 in such a manner that the edge 6.7 of the slab-shaped component 6.6 is aligned at least approximately parallel to an edge 6.5 of an at least partially covered supporting element 6.1. In a preferred embodiment, the edge 6.7 of a slab-shaped component 6.6 is at least approximately parallel to an edge of a clearance 7. In a particularly preferred embodiment, an edge 6.7 of a slab-shaped component 6.6 is in each case approximately parallel to an edge of a clearance 7, and at least one additional edge of the slab-shaped component 6.6 is in each case approximately parallel to an additional edge of a clearance 7. Hereby, for the first time, a slab-shaped component 6.6 is provided for covering a support structure 6 with a clearance 7, in which-owing to the parallelism of the edges 6.7 of the slab-shaped component 6.6 and of the clearance-further post-processing measures, such as a subsequent cutting out of the clearance 7 from the slab-shaped component 6.6, are reduced, or dispensed with in particularly preferred cases.

Furthermore, FIG. 6 discloses a space 8 between the supporting elements 6.1, 6.2, 6.3. The space 8 is delimited on one side by a slab-shaped component 6.6. In a downstream method step, the space 8 can be filled in particular with a filler material. This makes it possible to provide improved fire protection, sound insulation, and heat and/or cold protection. In a particularly preferred design embodiment, a structural component 9 and a filler material are provided in the space 8. The structural component 9 can hold the filler material at least approximately in position. The structural component 9 can be fastened to the adjacent supporting elements 6.1, 6.2, 6.3 and/or to the adjacent slab-shaped component 6.6. The structural component 9 can be used for further reinforcing the building element 5.

The production of multi-part building elements 5 comprises the following method steps: Providing and positioning supporting elements 6.1, 6.2, 6.3. Subsequently, the supporting elements 6.1, 6.2, 6.3 are fastened to one another. This provides a support structure 6. Subsequently, provided slab-shaped components 6.6 are deposited on the support structure 6. Depositing is performed in such a manner that the support structure 6 is at least approximately covered on one side. In an alternative method step, slab-shaped components 6.6 with a clearance 7 or at least a part of a clearance 7 are deposited on the support structure 6. This makes it possible to provide a building element with a clearance 7 for a passage, a door, a window and/or another component. After depositing, the slab-shaped components 6.6 are fastened to the support structure 6. The deposited slab-shaped components 6.6 form a first layer of slab-shaped components 6.6 on the support structure 6. If required for the building element to be produced, the method steps for depositing the slab-shaped components 6.6 can be repeated. Hereby, a building element with a support structure 6 and a plurality of layers of slab-shaped components 6.6 can be provided.

Subsequently, the support structure 6 is turned in such a manner that the support structure 6 bears on the slab-shaped components 6.6. This allows the space between the supporting elements 6.1, 6.2, 6.3 to be processed. Subsequently, a structural component 9 can be deposited on the slab-shaped component 6.6 in the space between the supporting elements 6.1, 6.2, 6.3. In a further method step, the structural component 9 can be fastened to the slab-shaped component 6.6 and/or the adjacent supporting elements 6.1, 6.2, 6.3. A filler material is then incorporated into the space between the supporting elements 6.1, 6.2, 6.3. The filler material is distributed and at least approximately held in position by means of the structural component 9.

In a downstream method step, slab-shaped components 6.6 are provided. These slab-shaped components 6.6 are positioned and deposited on the support structure 6 in such a manner that the structural component 9 and/or the filler material are/is enclosed from a plurality of sides by the support structure 6 and the slab-shaped components 6.6. In an alternative method step, slab-shaped components having a (protruding) additional component can be provided. These are positioned and deposited on the support structure 6 in such a manner that the additional component protrudes into the space between the supporting elements 6.1, 6.2, 6.3. The building element is subsequently at least temporarily stored before being conveyed to a construction site.

### LIST OF REFERENCE SIGNS

1 Main production line
1.1 Support structure station
1.2 Covering station
1.3 Module integration station
1.4 Turning station
1.5 Filling station
1.6 Additional covering station
1.7 Building element storage
2 First prefabrication line
2.1 First prefabrication installation
2.2 Second prefabrication installation
2.3 Third prefabrication installation
2.3a Module storage
2.3b Module conveyor unit
2.3c Assembly unit
2.4 Fourth prefabrication installation
3 Second prefabrication line
3.1 First storage
3.2 Slab cutting device
3.3 Second storage
4 Supporting structure of a factory shed
5 Building element
6 Support structure
6.1a Upper supporting element
6.1b Lower supporting element
6.2 Vertical supporting element
6.3 Internal supporting element
6.4 Connection point for supporting elements
6.5 Edge of a supporting element
6.6 Slab-shaped component
6.7 Edge of a slab-shaped component
7 Clearance
8 Space between the supporting elements
9 Structural component
9.1 Adapter piece
10 Housing
11 Empty tube
12 Cavity wall box
13 Sleeve carrier
14 Opening

1. Method for producing multi-part building elements (5) comprising a plurality of supporting elements (6.1, 6.2, 6.3), in particular support beams, comprising the following operating steps:
positioning the supporting elements (6.1, 6.2, 6.3) on a work table;
producing a support structure (6) by fastening the supporting elements (6.1, 6.2, 6.3) to one another and/or fixing the supporting elements (6.1, 6.2, 6.3) to one another;
providing and depositing a slab-shaped component (6.6) on the support structure (6), wherein the slab-shaped component (6.6) is deposited in such a manner that the support structure (6) is at least approximately covered on one side; and
fastening the slab-shaped component (6.6) to the support structure (6).

2. Method according to claim 1, wherein the slab-shaped component (6.6) is processed in a prefabrication line (2.3) in such a manner that the slab-shaped component (6.6) corresponds approximately, in particular in terms of an undersize, to a dimension, in particular to the height, of the support structure (6).

3. Method according to claim 1, wherein the slab-shaped component (6.6) is processed in a prefabrication line (2, 3) in such a manner that the slab-shaped component (6.6) at least partially has a clearance (7), in particular a clearance (7) for a passage, a door, a window and/or an additional component.

4. Method according to claim 3, wherein the clearance (7) of the slab-shaped component (6.6) is deposited and positioned on the support structure (6) in such a manner that an edge (6.7) of the slab-shaped component (6.6) is positioned approximately parallel to an edge of a clearance in the building element (5).

5. Method according to claim 1, wherein a slab-shaped component (6.6) is deposited, positioned and/or fastened on the support structure (6) by means of a robot, wherein the robot selects the slab-shaped component (6.6) from a supply of processed slab-shaped components and additional slab-shaped components in such a manner that the support structure (6) is at least partially covered, wherein the processed slab-shaped components are conveyed from a prefabrication line (2, 3) by way of a conveyor unit to the robot.

6. Method according to claim 1, wherein a multiplicity of slab-shaped components (6.6) are deposited on the support structure (6) in such a manner that the slab-shaped components (6.6) form a first layer on the support structure (6), wherein the contact region of two mutually adjacent slab-shaped components (6.6) is positioned at least approximately in the centre of a supporting element (6.1, 6.2, 6.3), wherein the slab-shaped components (6.6) in relation to the supporting elements (6.1, 6.2, 6.3) have a linear coefficient of expansion a which is 1.5 to 10 times, preferably 3 to 6 times, higher.

7. Method according to claim 1, wherein a slab-shaped component (6.6) is processed in a third prefabrication installation (2.5) in such a manner that an additional component is added to the slab-shaped component (6.6), wherein the additional component is a part of a shading system.

8. Method according to claim 7, wherein a slab-shaped component (6.6) is disposed on the support structure (6) in such a manner that the additional component of the slab-shaped component (6.6) protrudes into a space (8) between two supporting elements (6.1, 6.2, 6.3) of the support structure (6).

9. Method according to claim 7, wherein the building element (5) has a first layer of slab-shaped components (6.6), which has a clearance, in particular a clearance which is formed by a subtractive method on at least one slab-shaped component (6.6) of the first layer, wherein the clearance is designed in such a manner that the additional component protrudes in the assembled state into the clearance.

10. Method according to claim 1, wherein a plurality of supporting elements (6.1, 6.2, 6.3) are processed by a processing device on a main production line (1) so as to form a support structure (6) of a building element (5), while a component of a building element (5) is simultaneously processed on a prefabrication line (2, 3) which has a prefabrication installation in the form of an additional processing device for processing a component of a building element (5).

11. Method according to claim 10, wherein the component is processed on a prefabrication line (2, 3) and subsequently conveyed to a processing device of the main production line (1) in order to produce a building element (5).

12. Method according to claim 1, comprising further method steps:
turning the building element (5) in such a manner that the support structure (6) bears on the slab-shaped component (6.6) on a work table in such a manner that a space (8) between the supporting elements (6.1, 6.2, 6.3) is accessible;
inserting a structural component (9) onto the slab-shaped component (6.6) in the space (8) between the supporting elements (6.1, 6.2, 6.3) of the building element (5);
incorporating a filler material into the space (8) between the supporting elements (6.1, 6.2, 6.3), wherein the filler material is distributed in the space (8) and at least approximately held in position by means of the structural component (9).

13. Method according to claim 12, wherein the filler material comprises
a) a bulk material, in particular an inert bulk material, having a grain size of 1 to 10 mm, preferably having a grain size of 2 to 5 mm;
b) an injectable material, in particular a fibre-based and/or spherical material, preferably plastic balls and/or
c) an insertable material, in particular a fibrous web material, preferably a wood-fibre web material.

14. Method according to claim 12, wherein the structural component (9) has a three-dimensional structure with a plurality of struts and/or webs, which in top view has the shape of a multiplicity of circles, rectangles and/or honeycombs.

15. Method according to claim 12, wherein the structural component (9) comprises a fibrous material with a plurality of approximately hexagonal honeycomb structures, and has a slab-shaped fibrous element which covers the structural component on one side and holds a bulk material at least approximately in position, wherein the bulk material comprises a material with a bulk density of 1000 kg/m³ to 2000 kg/m³, preferably 1400 kg/m³ to 1600 kg/m³.

16. Method according to claim 12, comprising a further method step, wherein the support structure (6) is populated with slab-shaped components (6.6), wherein the slab-shaped components (6.6) are deposited on the support structure (6) in such a manner that a structural component (9) and/or a filler material are/is enclosed from a plurality of sides by the support structure (6) and the slab-shaped components (6.6).

17. Prefabrication line (2, 3), having
a) an assembly unit (2.3c) or a slab cutting device (3.2) for processing slab-shaped components (6.6); and
b) preferably a module storage (2.3a) or a second storage (3.3), wherein depositing of the processed slab-shaped components (6.6) in the module storage (2.3a) or in the second storage (3.3) is carried out in the reverse order for retrieval for a downstream processing step; and
c) a conveyor unit, in particular an autonomous conveyor unit, for feeding the processed slab-shaped components (6.6) to the main production line (1).

18. Prefabrication line (2, 3) according to claim 17, wherein the assembly unit (2.3c) or the slab cutting device (3.2) comprises a subtractive machining device, in particular a milling, sawing and/or cutting device, for adjusting the dimensions or for generating clearances in a slab-shaped component (6.6).

19. Prefabrication line (2, 3) according to claim 17, wherein the assembly unit (2.3c) comprises a processing device for fastening a component to a slab-shaped component (6.6), wherein the component comprises a part of a shading system.

20. Manufacturing plant for producing multi-part building elements (5), comprising a main production line (1) with a processing device and a prefabrication line (2, 3), in particular according to claim 17, wherein the prefabrication line (2, 3) is disposed in the region of the corresponding processing device of the main production line (1) in such a manner that the processed component of the prefabrication line (2, 3) is conveyed to the corresponding processing device of the main production line (1) at the time of further processing.

21. Manufacturing plant according to claim 20, wherein the main production line (1) has a first plurality of processing devices which are disposed in a line behind one another, and the first prefabrication line (2) has a second plurality of processing devices, wherein the first prefabrication line (2) is disposed on a side adjacent to the main production line (1), in particular between the main production line (1) and a supporting structure of a factory shed (4).

22. Manufacturing plant according to claim 20, wherein a second prefabrication line (3) has a first storage (3.1), a slab cutting device (3.2), in particular a subtractive machining device, in particular a milling, sawing and/or cutting device, for slab-shaped components (6.6), and a second storage (3.3) for processed slab-shaped components (6.6), wherein the first storage (3.1), the slab cutting device (3.2) and the second storage (3.3) are disposed in a line behind one another, and the second prefabrication line (3) is disposed in relation to the main production line (1) so as to be almost orthogonal to the main production line (1), and in particular on the opposite side of the main production line (1) in relation to a first prefabrication line (2), in such a manner that a conveyor unit is provided between the second storage (3.3) of the second prefabrication line (3) and one or a plurality of processing devices of the main production line (1).
